(19) United States
(12) Patent Application Publication
(10) Pub. No.: US 2016/0288022 A1
(43) Pub. Date: Oct. 6, 2016

(54) SYSTEM FOR PROCESSING WASTE WATER

(71) Applicant: ClearCove Systems, Inc., Victor, NY (US)

(72) Inventors: Terry Wright, Rochester, NY (US); Leonard A. Parker, Pittsford, NY (US); Robert S. Karz, Webster, NY (US); Jason E. Fox, Rochester, NY (US)

(21) Appl. No.: 14/985,842

(22) Filed: Dec. 31, 2015

Related U.S. Application Data
(63) Continuation-in-part of application No. 14/825,314, filed on Aug. 13, 2015.
Application No. 14/825,314 is a continuation-in-part of application No. 14/674,163, filed on Mar. 31, 2015.

(51) Int. Cl. B01D 21/24; B01D 21/30; B01D 61/02; B01D 21/00

(52) U.S. Cl. CPC B01D 21/2444; B01D 21/0018; B01D 21/0024; B01D 21/307; B01D 61/025; B01D 21/0012; B01D 2311/2626

(57) ABSTRACT

An apparatus and method for treatment of food process waste water, comprising a tank for receiving a food process waste water influent via an influent pump and discharging a treated food process waste water effluent via an effluent pump; a screen decanter disposed in the tank;, the screen having a porosity of about 50 micrometers; and a timer operationally connected to the floating decanter and the effluent pump. Solids are settled from the waste water and drawn off through the tank bottom after a supernatant fluid is drawn off through the floating decanter. The supernatant fluid is passed through a filtration and membrane water purification apparatus to generate purified water.

### RELATIONSHIP TO OTHER APPLICATIONS AND PATENTS

This application is a Continuation-In-Part of a pending U.S. patent application Ser. No. 14/825,314, filed Aug. 13, 2015, which is a Continuation-In-Part of a pending U.S. patent application Ser. No. 14/674163, filed Mar. 31, 2015, both of which are herein incorporated by reference in their entirety.

### TECHNICAL FIELD

The present invention relates to systems for processing waste water; more particularly, to such systems for handling biologically digestible materials in waste water generated typically in manufacturing and serving foods and potables, e.g., bakeries, breweries, dairies, restaurants, wineries, and the like; and most particularly, to a simple, small volume system for settling solids and adjusting pH in food process waste water to meet waste water quality standards for discharge into a municipal sewage system, and to further treat such food process waste water to meet higher quality standards for environmental discharge, process recycle, and/or potable water. Such further treatment can be exceedingly valuable for foods and potables manufacturers in, e.g., rural areas having no municipal sewage system, or arid regions where fresh water availability is limited and/or expensive.

As used herein, the term “food materials” should be taken to mean any and all biologically digestible organic materials, without limit; the term “food process waste water” should be taken to mean excess water and by-products, components beyond just water itself, used in the manufacture and/or use of food materials, which water must be treated to remove a portion of the dissolved and/or suspended food materials before being either sent to a waste water treatment facility or otherwise discharged to the environment; and “potable water” should be taken to mean water sufficiently pure to meet EPA standards for drinking water for humans.

### BACKGROUND OF THE INVENTION

Foods and potables manufacturing and handling typically require large volumes of input process water and generate substantial levels of biologically digestible materials dissolved and suspended in their waste process water. Additionally, the pH of such waste water may be substantially acidic or alkaline. When directed without pre-treatment to municipal waste water treatment facilities, such waste water can place a heavy and costly load on municipal waste treatment facilities. As a result, many communities impose a substantial cost on companies that generate such waste waters in the course of their operations. It is known to monitor the level of food materials in waste water output of companies and to levy a sewer surcharge on the companies accordingly. Many of these companies, for example, “microbreweries”, are relatively small in capitalization and output and thus are in need of a relatively inexpensive method and associated apparatus for pre-treating of process waste water to remove a substantial percentage of suspended food materials therefrom before the process waste water is discharged to a municipal sewer system. Fortuitously, the total volume of process waste water generated by many such operations may be relatively small, on the order of 1000 gallons/day or less, and therefore amenable to treatment by a method and apparatus in accordance with the present invention. Larger scale operations can also be supported by scaling up with multiple modules of the present invention.

Note: “Biological Oxygen Demand” (BOD), also known as Biochemical Oxygen Demand, is the amount of oxygen needed by aerobic microorganisms to decompose all the organic matter in a sample of water; it is used in the eco-sciences as a measure of organic pollution. As used herein, the term “BOD” also means more generally the unit volume load, both dissolved and suspended, of such organic material in waste water.

Further, Total Suspended Solids (TSS) is a water quality measurement which, as used herein, is expressed as the unit volume load of suspended solids, both organic and inorganic, in water. It is listed as a conventional pollutant in the U.S. Clean Water Act.

### EXAMPLE

The following example is directed to the characteristics and treatment of waste water generated by breweries. It should be understood that the disclosed method and apparatus are also well-suited to similar usage in many other types of food manufacturing and use as noted above.

Breweries have unique effluent characteristics and specific treatment needs. Breweries typically have BOD levels of 2,000-4,000 mg/l and TSS levels of 2,500-3,500 mg/l. The solids are fairly heavy and easy to settle out, and much of the dissolved organic load can also be precipitated out by dosing the waste water with coagulants. Brewery effluent can typically have a pH range of 2 to 12, depending on what process is taking place in the brewery. The pH may have to be adjusted on occasion to meet municipal requirements and also be bought into optimum range for effective chemical treatment. Brewery effluent can have fluctuating levels of BOD, TSS, and pH. There is also a chance that occasionally the brewery may have to waste a batch of beer, discharging the batch and introducing high levels of BOD into a municipal system.

Brewery waste water comprises several contributors to the total BOD and TSS load. Most of these are organic in nature and pose no serious threat to public health.

Yeast, spent grain, and hops are the building blocks of beer. Most of the wastes from these components typically are side streamed in the brewery and diverted as feed for farm animals. Inevitably, some of that waste also will get down the drain and thereby raise the BOD and TSS levels of the process effluent.

Wort is the liquid that will become beer once the yeast is added. Wort comprises fermentable and unfermentable sugars as well as starches and proteins. Because wort is rich in dissolved sugar, it is the primary contributor of BOD and SBOD (soluble BOD).

Fermented beer left in tanks after transfers and lost during packaging also contributes to the BOD and SBOD of the effluent leaving the brewery.

Beer has a characteristically low pH (typically 4-5.5) that can reduce the overall pH of the waste water.

For cleaning chemicals, breweries typically rely on caustic solutions for removing organic deposits from their process tanks. Acid is used on occasion, as are iodine-based sanitizers and peracetic acid for sanitizing tanks and equipment. These are diluted when used, but will still affect the pH of the final effluent.

Most of the water used by breweries leaves in the form of finished beer, so daily waste water flows are relatively low and comprise mostly cleaning water. A typical microbrewery may generate no more than about 200-300 gallons of process waste water per day, although naturally that volume will grow as production volumes grow.

What is needed is an appropriately-sized but scalable, relatively inexpensive waste water settling system for removing biologically-digestible solids from food process waste water to improve waste water quality for discharging into a municipal sewage system. Such a system preferably includes a screen decanter (also referred to herein as an “SBX” or “screen box”) for drawing off the clarified waste water from the upper reaches of the waste water in the tank. Preferably the screen porosity of an SBX is between about 25 micrometers and about 75 micrometers, most preferably about 50 micrometers.

What is further needed is a filtration and membrane system to further purify such treated food process waste water to meet quality standards for environmental discharge, and optionally for process recycle and/or potable water, especially in areas where available potable water is expensive and/or not readily available in large quantities. Such further purification treatment can be exceedingly valuable for foods and potables manufacturers in, e.g., rural areas having no municipal sewage system, or arid regions where fresh water availability is limited and/or expensive.

Filtration and membrane systems are known to be sensitive to the presence of particles in the influent stream which can readily and undesirably clog the very fine filters and membranes. Since the effluent from the upstream waste water settling system becomes the influent for the downstream filtration and membrane system, it is prudent that the influent be filtered again prior to entry into the membrane system. Accordingly, an additional fine filter may be provided downstream of the screen decanter and ahead of the membrane system. Preferably the filter porosity is between about 25 micrometers and about 75 micrometers, most preferably about 50 micrometers.

### SUMMARY OF THE INVENTION

The present invention includes improvements to the SBX design to enable more uniform flow and thus increased waste water processing capacity when the Enhanced Primary Treatment (EPT) unit is coupled to a membrane/filter system. The new design also includes a 50 micrometer screen filter either at the entrance to the SBX or ahead of the membrane/filter system to reduce maintenance requirements (e.g. back flushing) and extend membrane life for the membrane/filter system. The reduced maintenance comes from improved uniformity of flow through the 50 micrometer screen, thereby reducing fouling in local areas otherwise subjected to non-uniform high/peak flow channels. Preferably, the membrane/filter system includes its own 5 micrometer filter ahead of the membrane elements.

Briefly described, a system in accordance with the present application comprises a pretreatment (“EPT”) system to intercept and treat a process waste water effluent stream before it enters the municipal sanitary system, or before it is suitable for entry to environmental discharge or process recycle or human ingestion. Systems in accordance with the present invention can be scaled up or down to meet the needs and economic price point of even small operations/companies, and can then be readily scaled up as treatment demand increases.

The present system pumps the effluent stream from a discharge channel such as trench drains or a sump, either directly into a holding tank for settling and for pH balancing or dissolved solids adjustment or these operations can be accomplished as pre-treatment processes prior to entering the main tank. A sump pump is responsive to a signal such as a float switch in a sump or drainage trench. The collected discharge is transferred to the invention system's tank having a conical bottom with a manual discharge valve for removal of settled solids. The system has a chemical dosing mechanism to permit effluent adjustment. The supernatant is decanted using a decanter, e.g., a floating or vertically driven decanter, following a predetermined settling period.

The decanter preferably includes a screen, defining thereby an SBX, preferably an outer screen for filtering waste water as it enters the decanter. Preferably the screen porosity is between about 25 micrometers and about 75 micrometers, most preferably about 50 micrometers.

The decanter is equipped with a float switch to automatically activate it when a certain level in the tank is reached, to prevent overfilling the tank. The discharge pump is equipped with a timer that can be set to drain the tank slowly after a pre-set settling period time to reduce the load on the municipal sanitary system. Preferably, a solenoid valve also controlled by the timer is disposed in the drain line to prevent inadvertent siphoning of the tank via the floating decanter.

The EPT effluent, although partially clarified via coagulation and settlement processes, requires further processing before it is suitable for recycling/re-use. Small hole-size filters can be used for this purpose (‘membranes’ are defined by porosities of 20 micrometers and smaller), followed by increasingly finer membranes. However, membranes used in this manner are prone to clogging and require frequent maintenance (e.g. back flushing).

The discharge pump may be directed to a drain to a municipal sewage system or, preferably for further purification, to a self-contained waste water purification system comprising a feed pump, a pre-filter having a screen porosity preferably about 5 micrometers, a first filtration/membrane feed tank, a plurality of sequential filters/membranes of decreasing porosity, a reverse osmosis feed tank, at least one reverse osmosis membrane, and piping leading alternatively to drain or to further recycled use in manufacturing or as potable water

This invention comprises filtration design enhancements to the SBX to improve its clarification and filtration performance while decreasing its cost and reducing the concentration of entrained organic particles. These improvements make it possible to combine EPT, a fine filter screen, and membrane technology to make water recycling/re-use a practical alternative for many food and beverage processing applications, e.g., onsite human waste treatment at food/beverage sites in addition to treating their process waste.

In operation, many anticipated users of the present invention system have manufacturing operations that generate waste water only during the daytime. Thus, in an anticipated operating protocol the tank is filled progressively with food process waste water during the work day. Waste water pH and/or other characteristic may also be adjusted as needed in real-time or as a batch treatment once the tank is full. Settling of solids occurs during the nighttime hours when the waste water is tranquil, followed by decanting of the cleared supernatant effluent from the tank before the start of the next work day, after which the accumulated solids are also drawn off through the valve in the bottom of the tank for landfill, bio-digestion, or other disposal.

Further, in areas where there is no municipal waste water treatment facility, the permissible pollution levels of discharge from manufacturing processes into the environment via subterranean drainage field, lagoon, spray field, or natural watercourse is governed by environmental law. A system including provision for further purification of process effluent to meet environmental standards thus is highly desirable, beneficial, and cost effective for anticipated users of this invention.

Still further, in arid areas where abundant process water may be scarce and/or expensive, a purification system for recycling of process water back into the head end of the process, rather than discard, is highly desirable to allow businesses to start-up or existing operators to expand.

Thus there is a further need for a water purification system complementary to the process waste water settling system, which water purification system may be close-coupled to the process waste water settling system in a closed loop. In the present invention, a supplemental filtration and reverse osmosis system is attached, integral to, and downstream of the aforementioned processing steps. The supplemental system comprises a series of membrane filters, each of which is progressively finer. Filters are easily removed, replaced if fouled, or added if finer treatment levels are desired. The composite system therefore allows anticipated system users to select the level of filtration that best meets their onsite water usage requirements and meets their objectives for discharging to offsite waste water treatment operations or process recycle.

### BRIEF DESCRIPTION OF THE DRAWINGS

The present invention will now be described, by way of example, with reference to the accompanying drawings, in which:

FIG. 1 is a schematic drawing of an elevational cross-sectional view of a first embodiment of a primary treatment settling tank system in accordance with the present invention;

FIG. 2 is a schematic drawing of a waste water purification system for further treating the output of the primary treatment settling tank system shown in FIG. 1 to produce recyclable or potable water;

FIG. 3 is an isometric view from above of a first embodiment of a screen decanter in accordance with the present invention, showing an integral fine entrance filter in the porosity range of 25 micrometers to 75 micrometers;

FIG. 4 is an isometric view from below of the screen decanter shown in FIG. 3;

FIG. 5 is a front elevational view of the decanter shown in FIG. 3;

FIG. 6 is an elevational cross-sectional view taken along line 6-6 in FIG. 5;

FIG. 7 is detailed view taken in circle 7 in FIG. 6; and

FIGS. 8 through 11 are elevational views (FIG. 9 being isometric) of various embodiments of a decanter standpipe.

The exemplifications set out herein illustrate currently preferred embodiments of the invention, and such exemplifications are not to be construed as limiting the scope of the invention in any manner.

### DESCRIPTION OF THE PREFERRED EMBODIMENTS

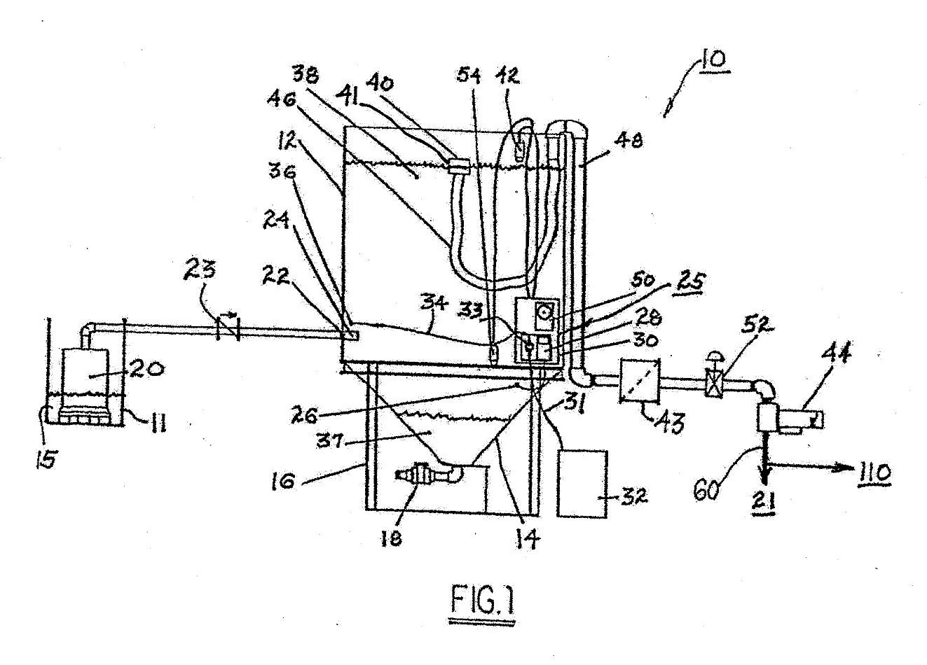

Referring now to FIG. 1, a system 10 for treatment of food process waste water is shown. System 10 comprises an elevated tank 12, e.g., a cylindrical 1000 gallon tank formed, e.g., of polyethylene or polypropylene or stainless steel or other material able to tolerate caustic by-product of food processing. Tank 12 includes hopper bottom 14, preferably conical as shown, and is mounted on a stand 16 providing access to a solids outlet valve 18 in hopper bottom 14.

Preferably, tank 12 is sized to hold and dilute an entire spoiled batch (e.g., of beer or wine) and, additionally, one day or more of process discharge. This allows the user to treat and dilute spikes in process discharge constituents, e.g., BOD, TSS, and/or pH. Untreated food process waste water effluent (tank influent) 15 from a user's trench drain or sump 11 flows into tank 12 via a conventional sump pump 20 and backflow preventer check valve 23. System 10 is functionally positioned in the user's waste water effluent line between user's sump 11 and a municipal sanitary sewer 21. Preferably, the tank influent connection 22 to tank 12 is, for example, PVC pipe, and is located in the cylindrical tank wall near the transition to conical hopper bottom 14 and includes a 90° elbow 24 to turn the flow within the tank substantially parallel to the tank wall to cause circular circulation of influent within the tank.

Conical hopper bottom 14 has an included cone angle selected from the group of cone angles consisting of at least 45°, 60°, and all angles therebetween.

System 10 includes a chemical dosing mechanism 25 that displays at least one chemical characteristic of interest in the influent and allows adjustment of that characteristic of the influent by addition of dosing chemicals, for example, alkali or acid to bring the pH into the required range before discharging of treated effluent. The chemical dosing mechanism includes a dosing pump probe 26 disposed within tank 12, preferably about five inches below the top of bottom 14. Probe 26 is connected to a pH controller and dosing pump 28 disposed in a control box 30. Dosing pump 28 is supplied with a dosing chemical via a first dosing hose 31 from a reservoir 32. The dosing chemical is injected via a tank valve 33 and second dosing hose 34 into supernatant influent 38 at location 36, preferably at a point about two inches above elbow 24.

For further BOD and TSS reduction, chemical coagulants (e.g., ACH, PAC,) can be dosed to the fluid in the tank specifically to reduce soluble BOD. Preferably, this is done at the end of each day of production to allow the maximum number of hours for settling of solids 37. Dosing rates are very low (generally 100-150 ppm) and have no adverse effect on the waste water stream.

During a predetermined settling period, the food process waste water is gravitationally separated into a settled solids fraction 37 and a clarified supernatant fraction 38. Supernatant 38 is decanted from the top down using a vertically-mobile decanter 40 that follows the liquid level in tank 12 rather than being a fixed opening in the side of tank 12 as in the prior art. Decanter 40 may be either a simple weir-type floating decanter, or preferably a screen decanter (SBX) for drawing off the clarified waste water from the upper reaches of the waste water in the tank. Preferably the screen porosity of the SBX is between about 25 micrometers and about 75 micrometers, most preferably about 50 micrometers, and preferably the screen is disposed at the entrance to the decanter, as described below.

Tank 12 may be equipped with an upper float switch 42 to automatically activate floating decanter 40 when a pre-set alarm level of supernatant 38 in tank 12 is reached. This prevents accidental overfilling and spilling of the tank. Supernatant 38 thus becomes the process effluent 60 from system 10. Screen decanter 40 is described in greater detail hereinbelow.

Discharge pump 44 is connected to decanter 40 via drain pipe or hose 46 and rigid PVC pipe 48. System 10 includes a multiple-setting timer 50 connected to a normally-closed solenoid valve 52 and effluent pump 44 that can be set for intermittent flow from tank 12, to drain the tank slowly over time to further reduce the instantaneous load on the municipal waste water treatment plant. The cycles can be determined by the operator and the municipality. If tank 12 fills completely, upper float switch 42 activates floating decanter 40, solenoid valve 52, and effluent pump 44 to pump just enough effluent from the tank to bring the level down to a safe operating level. Optionally, decanter 40 is fitted with a fine filter 41 as described above; or optionally decanter 40 is a non-screen decanter and the effluent discharge line 48 is configured with a fine filter 43 having porosity in the range of 25-75 micrometers, as described in detail below.

In one anticipated mode of operation of system 10, daytime food processing operations cease between approximately 8:00 pm and 6:00 am, giving system 10 enough time to allow settling of solids and then to empty itself before the start of the next production day. When the level of supernatant 38 reaches lower float switch 54, floating decanter 40, solenoid valve 52, and effluent pump 44 are deactivated. After tank 12 is emptied, an operator drains the settled solids from the conical bottom 14 of tank 12 at the start of each day of production.

In many applications equipped in accordance with the present invention, some solids and other contributors of BOD can be collected, or “side-streamed”, from the various point sources of discharge throughout the facility, and can be captured in, for example, nylon filter bags. This can reduce significantly the amount of solids entering system 10 and can lower the total BOD level as well.

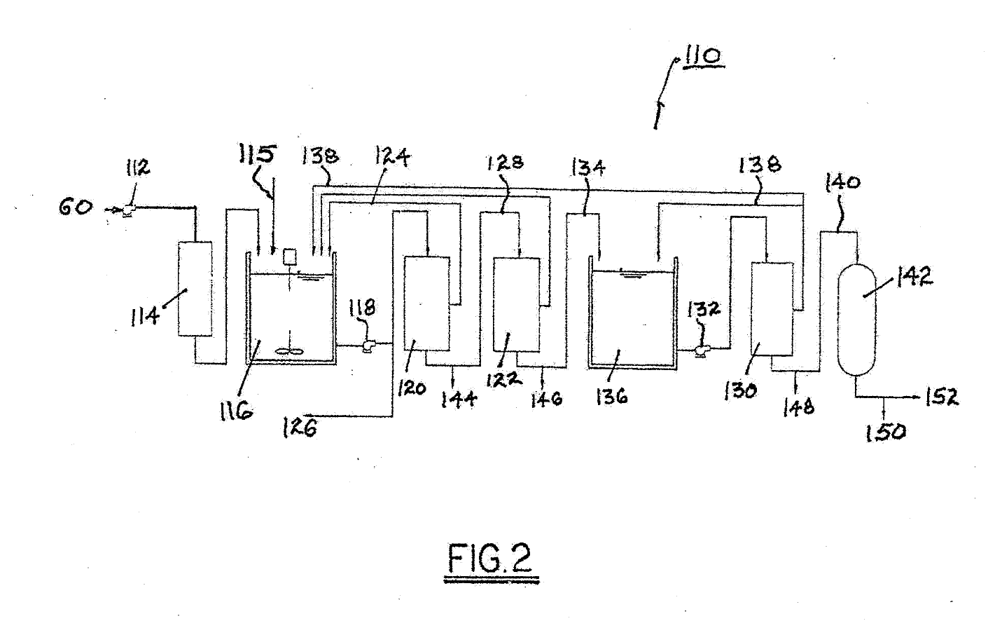

Referring now to FIG. 2, a currently preferred embodiment of a filtration and membrane system 110 to further purify treated food process waste water to meet BOD or other quality standards for environmental discharge, and optionally for process recycle and/or potable water, is shown.

In operation of system 110, wastewater effluent 60 from system 10 (FIG. 1) is pumped by a first feed pump 112 through a 5-micron cartridge filter 114 for the removal of any larger suspended solids. Filtrate from filter 114 is discharged into a first feed tank 116 wherein chemicals to enhance downstream treatment or prevent scaling may be added or pH may be adjusted via injection apparatus 115.

The mixed contents of first feed tank 116 are pumped via a second feed pump 118 through one or more membrane canisters 120,122. Preferably, first membrane canister 120 houses a microfiltration (MF) or ultrafiltration (UF) membrane to remove colloidal solids in excess of 0.015 microns in size, which serves to remove fats and proteins. The reject from first membrane canister 120 is returned via line 124 to first feed tank 116 which acts as a concentrator to increase the solids content in first feed tank 116 until such time as a portion 126 of the contents thereof is discharged to the sludge tank 12 of system 10.

Permeate 128 from first membrane canister 120 exits under pressure and passes through second membrane canister 122 containing a nanofiltration (NF) membrane that rejects particles larger than 0.001 microns, which includes some metal ions, complex sugars, and synthetic dyes. The nanofiltration membrane allows simple sugars, alcohol, ammonia, short-chain organics, most metal ions, and salts to pass. It should be noted that the actual apertures of the MF, UF, and NF membranes may vary from manufacturer to manufacturer, so the contaminants rejected or passed may also vary.

The reverse osmosis (RO) membranes in third membrane canister 130 operate at a pressure greater than the operating pressure of the MF, UF, and NF membranes in first and second canisters 120,122, so an intermediate pump 132 is required. Therefore, permeate 134 from second canister 122 discharges under exit pressure into an RO feed tank 136. Here, chemicals may be added and the treated permeate 134 is pumped into the RO membrane in third canister 130. The RO membrane rejects metal ions, salts, sugars, and most short chain organics; however, alcohol and some ammonia may pass the RO membrane. The RO reject 138 is returned to RO feed tank 136 or the MF/UF/NF feed tank 116 for further processing.

The permeate 140 from third canister 130 discharges under pressure into a media canister 142 where activated carbon or other adsorbent may be employed to remove some of the remaining organics, or an ion-selective resin may be used to remove the ammonia.

All of the above-described steps may be required to produce a high quality effluent approaching or meeting drinking water standards. Alternatively, only selected steps may be necessary to accomplish a lower degree of treatment or the removal of a specific contaminant. The process steps can also be altered on client by client basis based on the nature of the wastewater, contaminants to be removed, and effluent requirements. Preferably, system 110 further comprises sample ports 144,146,148,150 to permit gauging the performance of each process step, as well as to judge the performance of different membranes and media.

System effluent 152 may be drawn off and used as purified process water in any desired manner, and further may be recycled (not shown) into the manufacturing process (not shown) that creates the need for systems 10,110.

One enabler to a viable water recycling/reuse system is the EPT itself which separates out sufficient particulate matter to make a high efficiency SBX possible. Additional classification is accomplished by using a fine screen filter in the SBX.

Fine filters, such as in the range of 25 microns to 75 microns, are susceptible to fouling and clogging similar to membranes. Remedially, the key to performance of the SBX itself is to create conditions that provide uniformity of flow across all regions of the fine screens. Extensive modelling is required to identify configurations that deliver uniform flow both in the vertical and horizontal planes. Without flow uniformity, high flow areas of each screen will clog more quickly requiring early maintenance or replacement or otherwise render screens and membranes unusable in many waste treatment applications.

As described below, a particularly useful SBX arrangement involves a plurality of cylindrical screens, e.g., three, mounted on a common platform including a drain manifold. The standpipe within each cylinder has a graduated series of openings, larger at the top than at the bottom, to compensate for the increased hydrostatic pressure in the lower regions of each screen. The plurality of standpipes are connected to the common platform that includes a central manifold drain pipe connected to an EPT drain pipe or hose.

Cylindrical screens are readily fabricated, and the design may make use of low cost light weight PVC pipe. Depending on the characteristics of the wastewater influent, these screens may have openings as small as 50 micrometers. This is the upper limit for input to a membrane filter system. However, SBX screens are easily back flushed, so for situations where the larger particles are encountered, longer life/less maintenance may be achieved by using larger screen openings at the SBX and inserting a 50 micron screen between the SBX and the filter/membrane system.

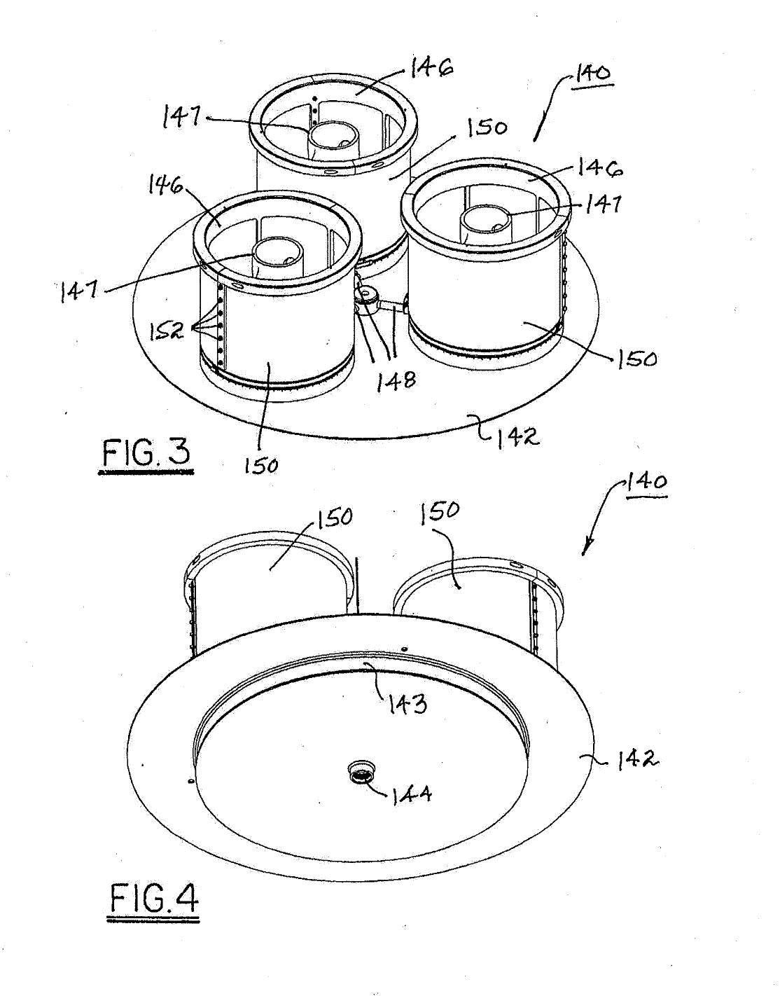

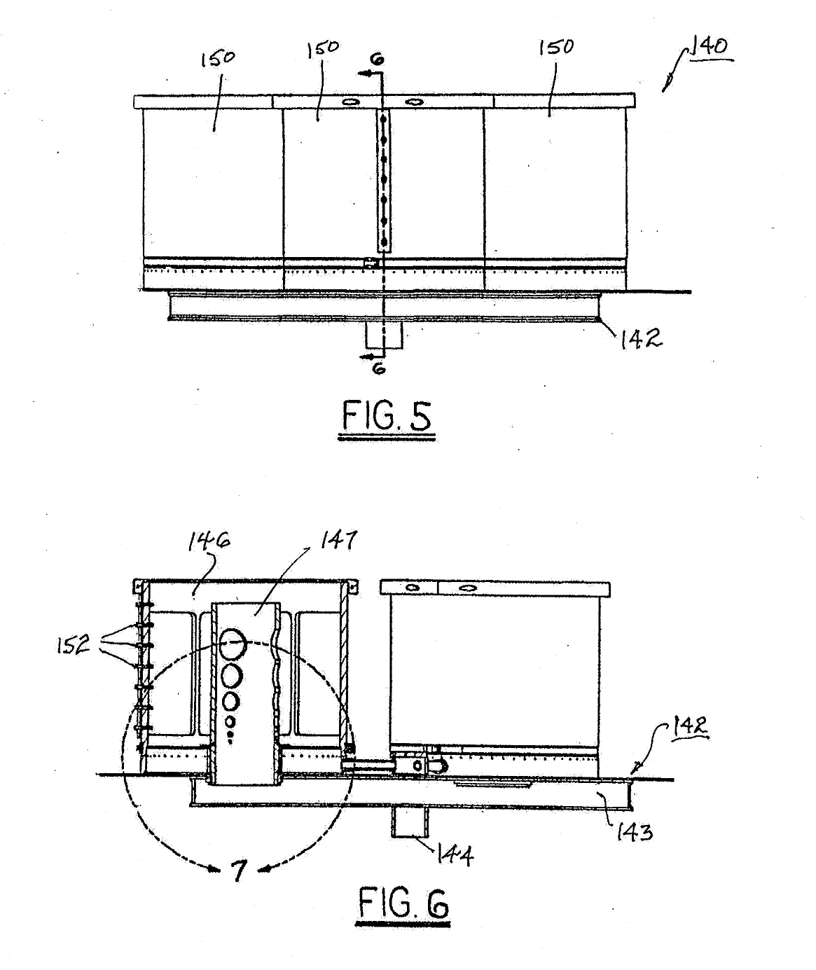

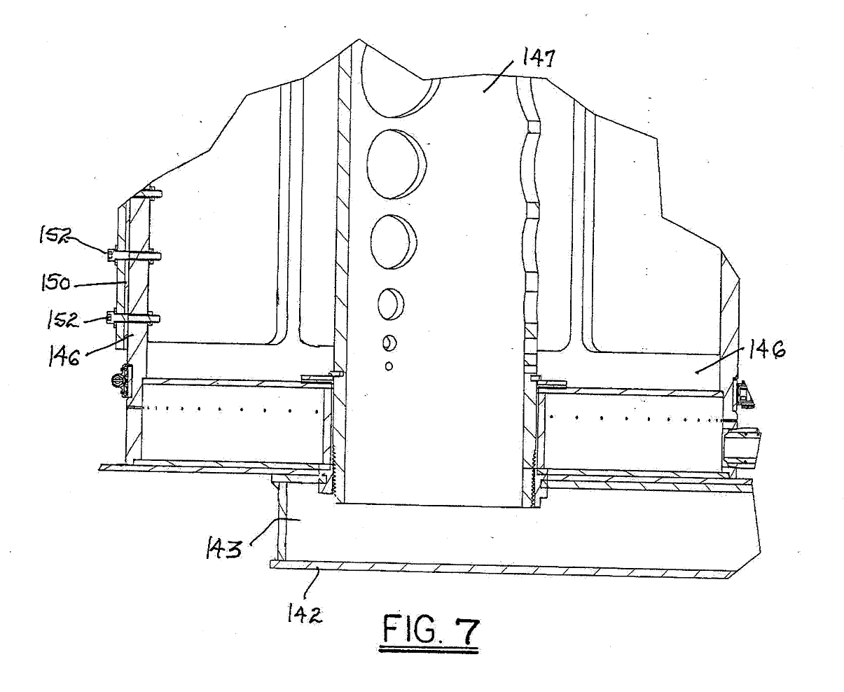

Referring now to FIGS. 3 through 11, an exemplary screen decanter 140 in accordance with the present invention comprises a platform 142 including a drain manifold 143 having a central drain opening 144. Three decanter frames 146 are mounted to platform 142, and each frame 146 includes a perforated central standpipe 147 connected to drain manifold 143 by a connecting pipe 148. Each frame 146 is surrounded by a cylindrical screen 150 connected to frame 146 as by screws 152 in such a fashion that all influent flow entering frames 146 must pass through a screen 150. Preferably, screens 150 have a porosity in the range of 25-75 micrometers, and most preferably about 50 micrometers.

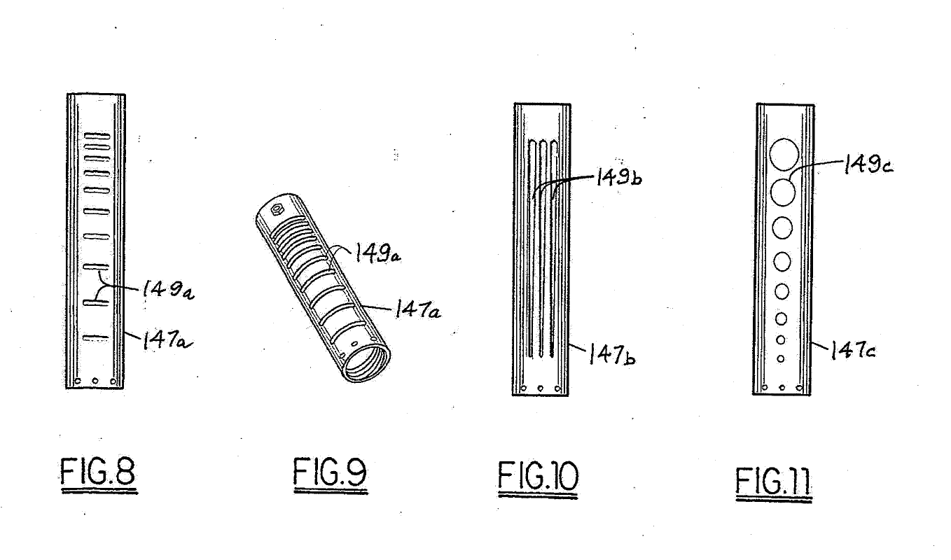

In operation, screen decanter 140 is partially submerged in supernatant 38. (FIG. 1) such that much greater lateral flow can be achieved into the decanter than over a simple weir. Further, the three cylindrical screens 150 provide a relatively large surface area for filtration of supernatant 38 as it enters the decanter. However, because decanter 140 is submerged to an operating depth, the hydrostatic head at the bottom of the screen is greater than at the surface of the supernatant, which would cause a non-uniform flow through the screen from top to bottom. To maximize working life between cleanings of the screen, it is desirable that lateral flow through the screen be substantially the same at all points. Therefore, to equalize lateral flow at all depths of screen immersion, each standpipe 147 is perforated in an aperture pattern contrary to the hydrostatic head imposed on the standpipe to allow less flow resistance at lesser heads and greater flow resistance at greater heads. Exemplary standpipes 147a,b,c comprising respective exemplary aperture patterns 149a,b,c are shown in FIGS. 8 through 11.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. A system for treatment of waste water generated by food processing, comprising:
a) a tank for receiving a food process waste water influent and for discharging a treated food process waste water effluent;
b) a decanter disposed in said tank;
c) a valved outlet formed in the bottom of said tank; and
d) a filtration and membrane water purification apparatus,
wherein said decanter is selected from the group consisting of screen and non-screen, and
wherein the porosity of screen in said screen decanter is between 25 micrometers and 75 micrometers.

2. A system in accordance with claim 1 further comprising:
a) an influent pump for delivering said food process waste water influent to said tank;
b) an effluent pump for discharging said treated food process waste water effluent from said tank;
c) an upper level float switch operationally connected to at least said effluent pump;
d) a lower level float switch operationally connected to at least said effluent pump; and
e) a timer operationally connected to at least said effluent pump.

3. A system in accordance with claim 1 wherein said screen decanter comprises:
a) a platform including a drain manifold;
b) at least one frame disposed on said platform;
c) at least one standpipe disposed within said frame and connected to said drain manifold; and
d) at least one screen disposed on said at least one frame.

4. A system in accordance with claim 3 comprising a plurality of said frame, said standpipe, and said screen.

5. A system in accordance with claim 3 wherein said screen has a porosity between about 25 micrometers and about 75 micrometers.

6. A system in accordance with claim 1 wherein said filtration and membrane water purification apparatus comprises:
a) at least one membrane selected from the group consisting of microfiltration and ultrafiltration; and
b) a reverse osmosis membrane.

7. A system in accordance with claim 6 further comprising a first feed pump, a first cartridge filter, pH adjusting apparatus, and a first feed tank in hydraulic communication with said at least one membrane.

8. A system in accordance with claim 7 wherein said first cartridge filter has a porosity of about 5 micrometers.

9. A system in accordance with claim 6 further comprising a reverse osmosis feed tank and second feed pump in hydraulic communication with said at least one membrane and said reverse osmosis membrane.

10. A system in accordance with claim 6 further comprising an adsorbent in hydraulic communication with said reverse osmosis membrane.

11. A system in accordance with claim 10 wherein said adsorbent comprises activated carbon.

12. A system in accordance with claim 1 wherein purified effluent from said filtration and membrane water purification apparatus is suitable for use in said food processing.

13. A system in accordance with claim 1 wherein purified effluent from said filtration and membrane water purification apparatus is usable as potable water.

14. A system in accordance with claim 1 wherein purified effluent from said filtration and membrane water purification apparatus meets environmental standards for discharge into public waterways.

15. A system in accordance with claim 1 further comprising a filter disposed between said decanter and said filtration and membrane water purification apparatus.

16. A system in accordance with claim 15 wherein said filter has a porosity between about 25 micrometers and about 75 micrometers.
